(19) United States
(12) Patent Application Publication
(10) Pub. No.: US 2007/0040891 A1
(43) Pub. Date: Feb. 22, 2007

(54) Community message board

(76) Inventor: Jacob Calloway, San Diego, CA (US)

Correspondence Address: PETER K HAHN;LUCE, FORWARD, HAMILTON, SCRIPPS, LLP., 600 WEST BROADWAY, SUITE 2600, SAN DIEGO, CA, 92101, US

(21) Appl. No.: 11/205,623

(22) Filed: Aug. 17, 2005

(51) Int. Cl. H04N 7/14

(52) U.S. Cl. 348/14.01

(57) ABSTRACT

The present invention provides a community message board for a plurality of users at a single location such as a home or office, the community message board comprising a monitor for broadcasting audio and video messages, a video camera for capturing video inputs, a microphone for recording audio inputs and a software program comprising machine-readable instructions for processing user inputs and controlling peripheral devices including the video camera and microphone.

### FIELD OF THE INVENTION

The present invention is directed to a community message board, and more particularly to a community message board for a plurality of people at a single location such as a residence or office.

### BACKGROUND OF THE INVENTION

U.S. Patent Publication No. 2004/0022369 (“the '369 publication”) discloses a telecommunications system that provides an answering service for subscribers. The system includes a plurality of subscriber terminals for storing parameters associated with selectable profiles and controlling subscriber terminal functions. Each subscriber terminal includes a user interface including a display, a keyboard, a camera, microphone and a loudspeaker, wherein a service subscriber may utilize the user interface to record a new message (e.g., including text, speech, images, video clips, and/or multimedia messages).

One drawback of the above-identified patent publication is that it does not involve a community message board for plurality of users at a single location such as a residence, office, house, apartment or other single location. A further drawback of the '369 publication is that it does not provide a message board that functions as a community notepad and calendar comprising a free access electronic planner for a single location, wherein anyone may post a message for any user, including general posts directed to all users. Additionally, the '369 publication does not teach a community message board providing a plurality of personal calendars, wherein each personal calendar is tailored for a particular user to provide a reminder important dates and events. Moreover, the '369 publication does not disclose the use of a community message board in a security mode, wherein the camera continuously records while the flat panel displays a slide show or mirror screen.

In view of the above, there exists a need for a community message board comprising a video screen such as a flat panel touch screen to be mounted on a wall or other base, a camera such as a digital video camera having video and still photo capabilities, a microphone for recording audio inputs, one or more speakers, one or more memory card disk drives, and a data port such as a USB port for downloading photos, audio and video.

There also exists a need for a community message board including a video mailbox for each of a plurality of users, for recording and sending messages to other users of the community message board.

There further exists a need for a community message board having a personal calendar for each of a plurality of users, wherein each personal calendar is tailored for a particular user to provide a reminder of holidays, birthdays, appointments, deadlines, meetings and other events.

Additionally, there exists a community message board comprising a community notepad and calendar comprising a free access electronic planner for a household, wherein anyone may post a message for any user, including general posts directed to all users

There also exists a need for a community message board including a security mode, wherein a camera continuously records while the community message board displays a slide show or mirror screen.

There additionally exists a need for a community message board including a camera and a motion detector, wherein the camera only records when movement is detected.

There further exists a need for a community message board that is used as a photo album for the creation of slide shows.

There also exists a need for a community message board that is used as a photo bank for downloading photos and videos into a photo album.

In addition, there exists a need for a community message board that is used as a community notepad and calendar that may comprise a free access electronic planner for a household, wherein anyone may post a message for any user, including general posts directed to all users.

### SUMMARY OF THE INVENTION

In view of the foregoing, it is an object of the present invention to provide a community message board comprising a video screen such as a flat panel touch screen to be mounted on a wall or other base, a camera such as a digital video camera having video and still photo capabilities, a microphone for recording audio inputs, one or more speakers, one or more memory card disk drives, and a data port such as a USB port for downloading photos, audio and video.

It is another object of the invention to provide a community message board including a video mailbox for each of a plurality of users, for recording and sending messages to other users of the community message board.

It is a further object of the invention to provide a community message board having a personal calendar for each of a plurality of users, wherein each personal calendar is tailored for a particular user to provide a reminder of holidays, birthdays, appointments, deadlines, meetings and other events.

It is an additional object of the invention to provide a community message board comprising a community notepad and calendar comprising a free access electronic planner for a household, wherein anyone may post a message for any user, including general posts directed to all users

It is another object of the invention to provide a community message board including a security mode, wherein a camera continuously records while the community message board displays a slide show or mirror screen.

It is yet another object of the invention to provide a community message board including a camera and a motion detector, wherein the camera only records when movement is detected.

It is a further object of the invention to provide a community message board that is used as a photo album for the creation of slide shows.

It is another object of the invention to provide a community message board that is used as a photo bank for downloading photos and videos into a photo album.

In addition, it is an object of the invention to provide a community message board that is used as a community notepad and calendar that may comprise a free access electronic planner for a household, wherein anyone may post a message for any user, including general posts directed to all users.

The preferred embodiment of the present invention is directed to a community message board comprising a video screen such as a flat panel touch screen to be mounted on a wall or other base, a camera such as a digital video camera having video and still photo capabilities, a microphone for recording audio inputs, one or more speakers, one or more memory card disk drives, and a data port such as a USB port for downloading photos, audio and video.

According to the preferred embodiment, the community message board is adapted for a plurality of users at a single location such as a home or office. The community message board comprises a monitor for broadcasting audio and video messages, a video camera for capturing video inputs and a microphone for recording audio inputs. The monitor may comprise a flat panel touch screen including a touch screen keyboard for entering alphanumeric text, whereas the video camera comprises a digital video camera having video and still photo capabilities.

The community message board may further comprise a microprocessor for controlling the functionality of the message board, memory for storing audio and video data, interface circuitry for providing user interface functionality, and input/output circuitry for communicating with one or more peripheral devices such as the video camera, microphone and speakers. Additionally, an audio/video message circuit is provided such that one or more desired audio/video messages associated with displayed icons and text regions can be played upon touching a selected icon or text region using a finger or a stylus. Digital information representing the desired audio/video message is retrieved from the memory, converted to an analog signal and transmitted to the speakers to produce the desired audio message perceptible to a human.

Residing on the community message board is a software program comprising machine-readable instructions for processing user inputs and controlling peripheral devices including the video camera and microphone. The software program provides a series of screens to be selectively displayed on the monitor, including a home screen, a user mailbox screen, a user calendar screen, a community calendar screen, a security mode screen and a media center screen. In particular, each user is provided with a user mailbox for sending audio/video messages to other users of the community message board. Each user is also provided with a personal calendar for entering and automatically reminding the user of selected holidays, birthdays, appointments, deadlines, meetings and other dates. The software program also provides a community calendar that is accessible by all users, wherein any user may post a message for any other user or combination of users, including general posts that are directed to all users.

The software program of the invention further provides a security mode in which the video camera is employed as a monitoring device. For example, the video camera may be set to continuously record a predetermined location while the community message board displays a slide show or mirror screen. Alternatively, the video camera may include a motion detector such that the video camera is configured to record only when movement has been detected.

### BRIEF DESCRIPTION OF THE DRAWINGS

FIG. 1 is a front view of a preferred community message board in accordance with the principles of the present invention;

FIG. 2 is a side view of the community message board of FIG. 1;

FIG. 3 is an exploded bottom view of the community message board of FIG. 1;

FIG. 4 is a rear view of the community message board of FIG. 1;

FIG. 5 is a schematic diagram of the electrical circuitry of the community message board of the present invention;

FIG. 6 is an exemplary representation of a home screen of the community message board of the present invention;

FIG. 7 is an exemplary representation of a user mailbox screen of the community message board of the present invention;

FIG. 8 is an exemplary representation of a user calendar screen of the community message board of the present invention;

FIG. 9 is an exemplary representation of a community calendar screen of the community message board of the present invention;

FIG. 10 is an exemplary representation of a security mode screen of the community message board of the present invention;

FIG. 11 is an exemplary representation of a media center screen of the community message board of the present invention;

FIG. 12 is an exemplary representation of a create messages screen of the community message board of the present invention; and

FIG. 13 is an exemplary representation of the community message board of the present invention.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

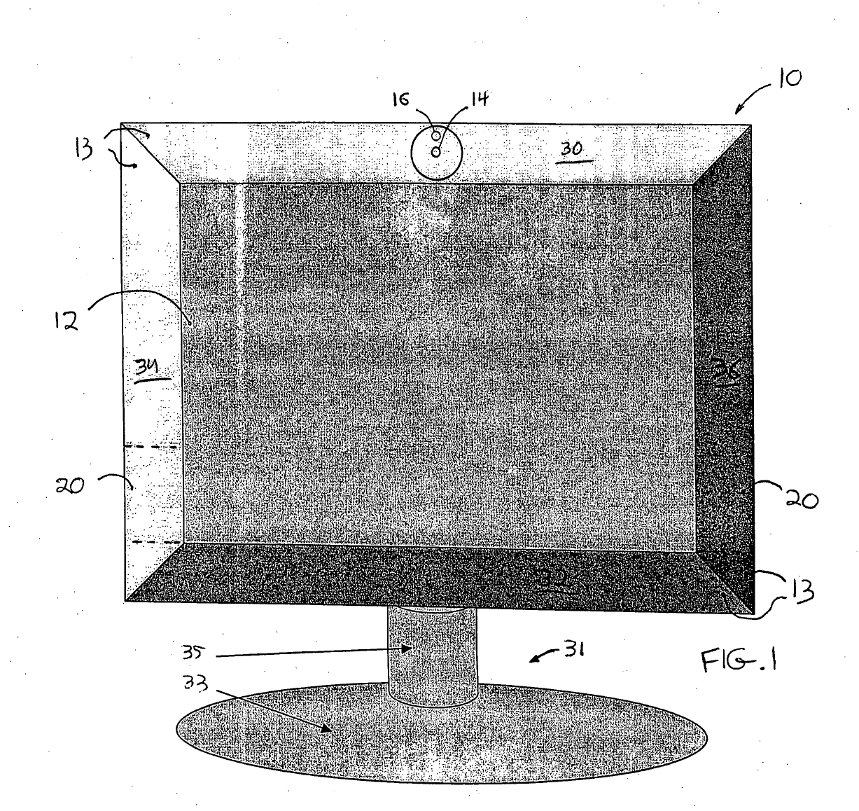

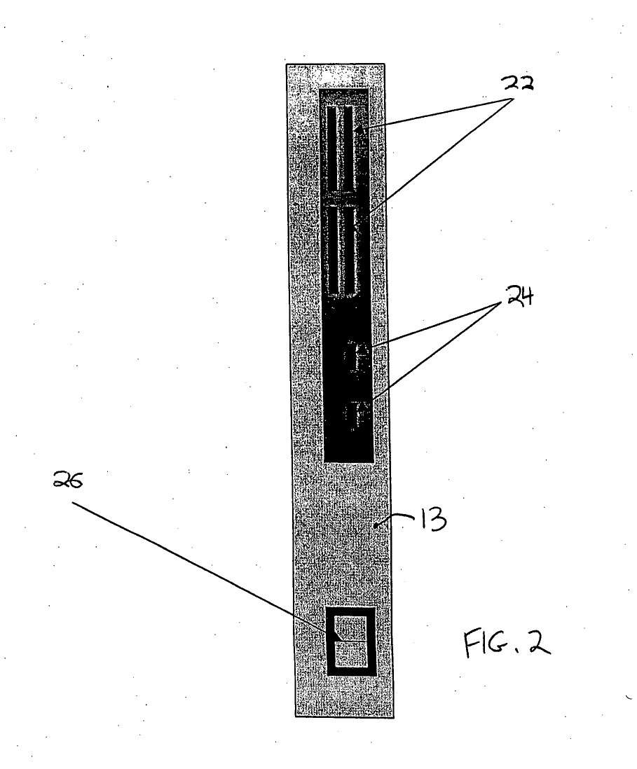

Referring to FIGS. 1 and 2, the preferred embodiment of the present invention is directed to community message board 10 comprising a flat panel touch screen monitor 12 disposed within a frame 13 to be mounted on a wall or other base, video camera 14 for recording video inputs, microphone 16 for recording audio inputs and speakers 20. Monitor 12 may include a touch screen keyboard for entering alphanumeric text when needed. Alternatively, a conventional keyboard may be employed for entering alphanumeric text. Video camera 14 preferably comprises a digital video camera having video and still photo capabilities. Advantageously, the video camera 14 allows an image to be captured electronically and then downloaded into the memory of the community message board 10.

In accordance with the preferred implementation of the invention, the community message board 10 is adapted to be used by a plurality of users at a single location such as a residence, office, house, apartment or other single location. Community message board 10 may function as a community notepad and calendar comprising a free access electronic planner for a single location, wherein anyone may post a message for any user, including general posts directed to all users.

According to an alternative embodiment of the invention, the community message board 10 may be part of a network of community network board that are in communication as part of a network such as a local area network (LAN), wide area network (WAN), or the Internet. Such networking capabilities permit one community message board disposed at a first location to communicate with other community message board disposed at different locations, for example via email, instant messages and other known methods of electronic communication. According to further embodiments, the community message board 10 may be provided in wireless communication with user cellular phones and other hand held wireless electronic devices. For example, the community message board 10 may be programmed to automatically send a notification to the appropriate user cellular phone (or other hand held wireless electronic device) when the user has a message on the community message board 10.

As depicted in FIG. 2, community message board further comprises one or more memory card disk drives 22, one or more data ports 24 and on/off toggle switch 26, which are disposed generally within the frame 13 on one side of the community message board 10. The frame 13 includes a top section 30, bottom section 32, and side sections 34, 36. According to an aspect of the invention, a plurality of frame styles, colors and materials are provided such that an individual frame 13 may be chosen to match the look and feel of the home, office or other location of the community message board.

Memory card disk drives 22 may comprise SCANDISK SD memory cards, which offer a combination of high storage capacity, fast data transfer rates, and good security features in a memory card about the size of a postage stamp. Data ports 24 may comprise a USB (universal serial bus) port for downloading photos and video. The USB port may also be employed to download audio files such as musical selections. Additionally, the data ports 24 enable a user to attach mice, keyboards, printers, modems, palm pilots, cameras and other peripheral equipment to the community message board 10. According to some embodiments of the invention, the data ports 24 may further include other ports such as parallel ports and serial ports.

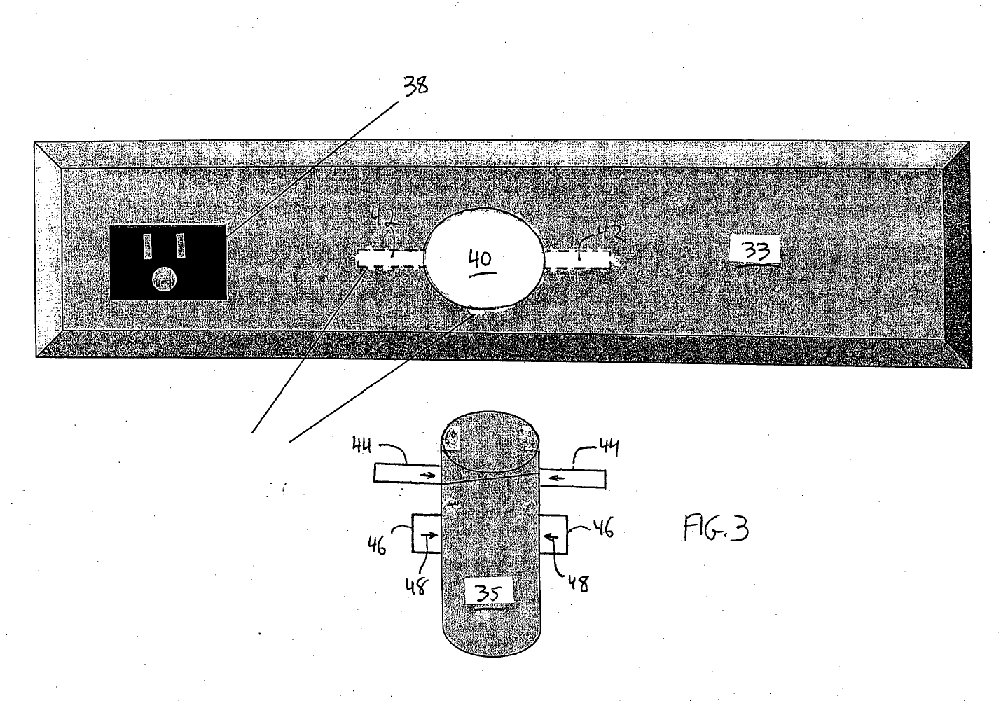

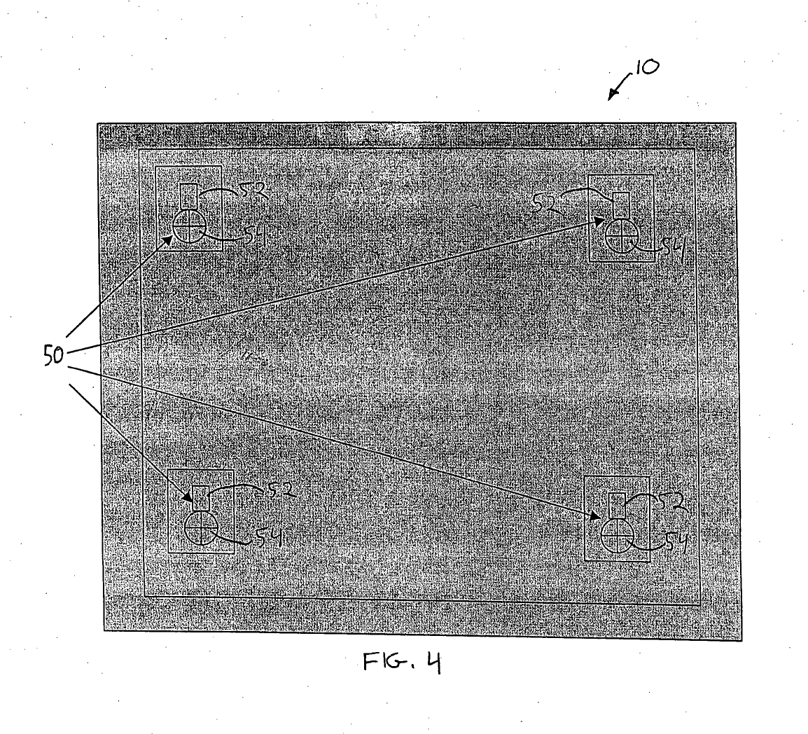

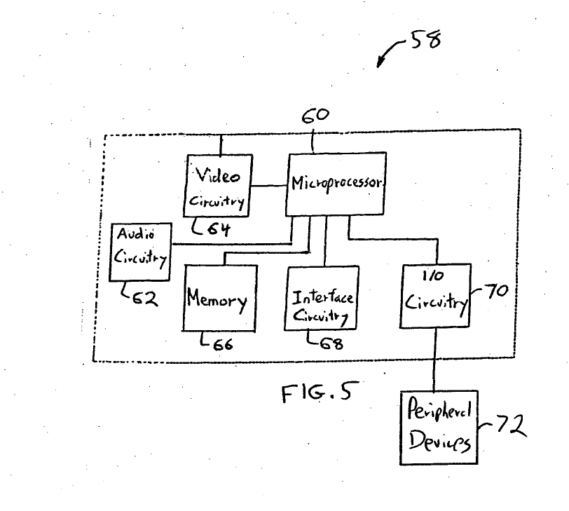

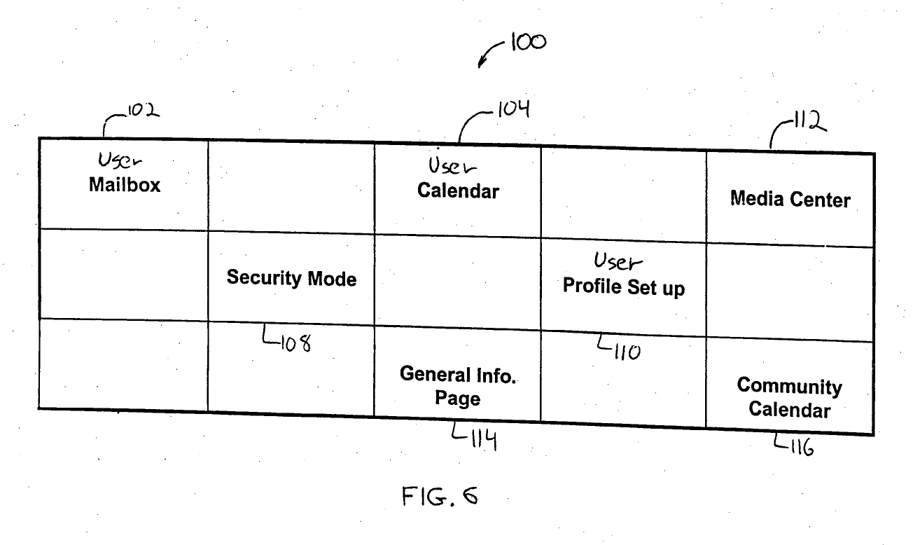

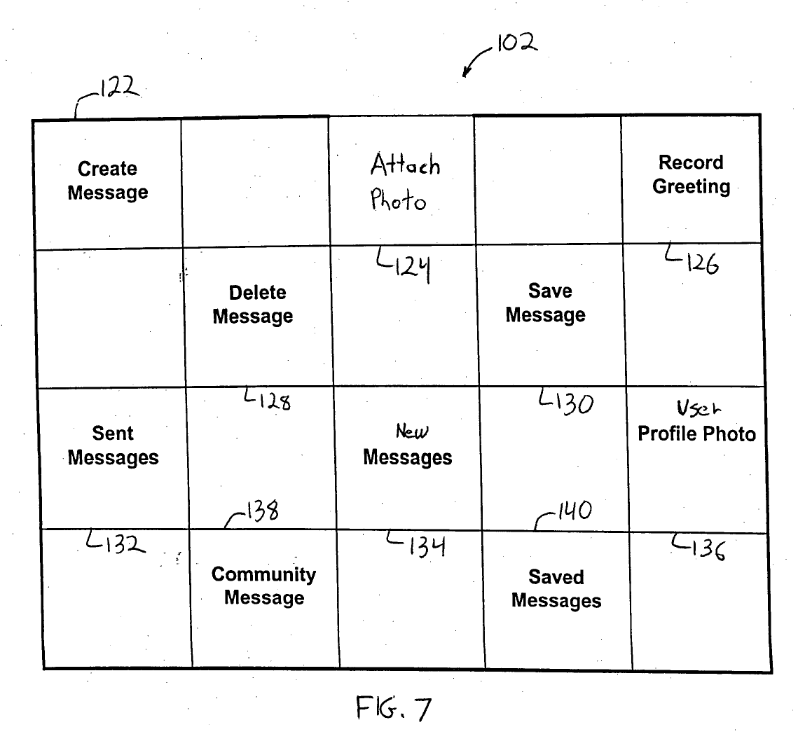

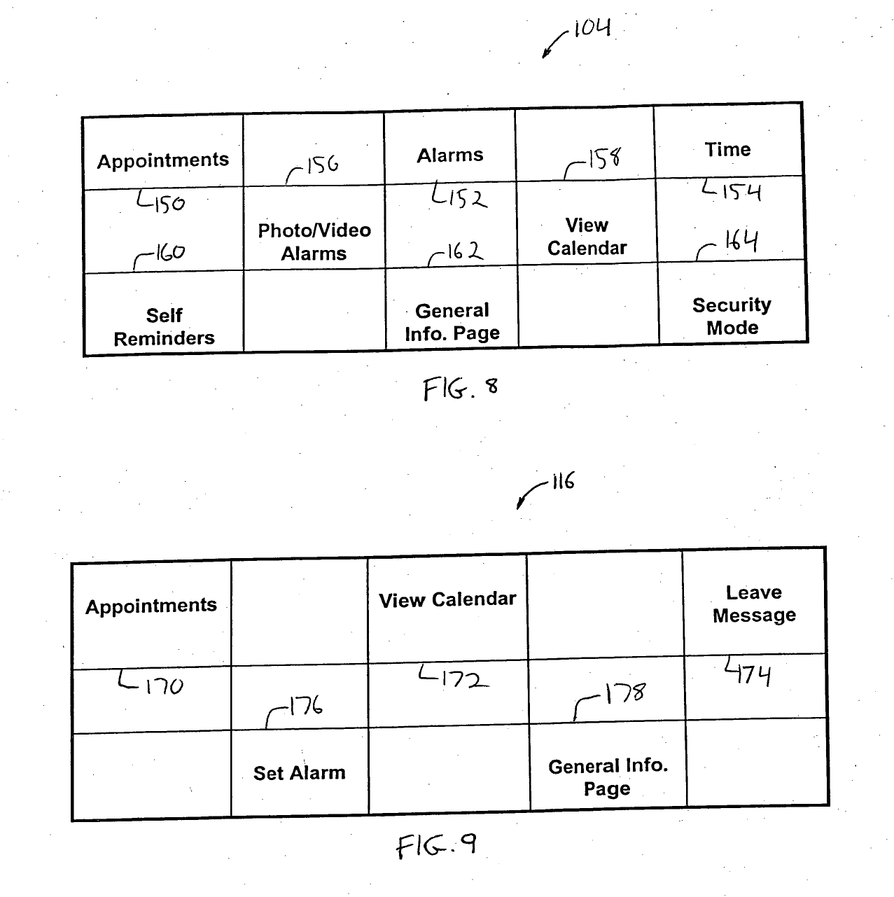

In the illustrated embodiment, community message board 10 further comprise a stand 31 for mounting the community message board on top of a substantially flat surface. Stand 31 comprises a substantially planar base member 33 and a vertical extension 35 for releasable attachment to the frame 13. As depicted in FIG. 3, bottom section 32 of the frame 13 includes a standard male power cord socket 38 for plugging the community message board 10 into a conventional electrical socket. Alternatively, the community message board 10 may be powered by way of standard batteries or rechargeable batteries.

With further reference to FIG. 3, bottom section 32 of frame 13 further comprises a recess 40 for slidably receiving vertical extension 35 of stand 31, and a pair of recesses 42 for slidably receiving a pair of retractable pins 44. Specifically, retractable pins 44 may be retracted within vertical extension by depressing tabs 46 in a direction indicated by arrows 48. One the pins 44 are retracted, vertical extension is slid into recess 40 until the pins pop out into recesses 42. According to an alternative embodiment of the invention the stand may comprise an easel such that the community message board is adapted to rest on the easel similar to the manner in which a painting rests in an artist's easel.

Referring to FIG. 4, according to some embodiments of the present invention, the community message board 10 is provided with one or more wall mounts 50 for releasably attaching the community message board 10 to a base such as a wall or other substantially flat mounting surface. Wall mounts 50 may include openings or tabs 52 for receiving fasteners such as screws 54 or nails that are attached to the wall or other mounting surface.

FIG. 5 is a schematic diagram 58 showing the electrical circuitry of the community message board 10, including microprocessor 60 for controlling the functionality of the message board, audio circuitry 62, video circuitry 64, memory 66 for storing audio and video data, interface circuitry 68 for providing user interface functionality, and input/output circuitry 70 for communicating with one or more peripheral devices 72 such as video camera 14, microphone 16 and speakers 20. The electrical circuitry may be housed within one or more recesses within the frame 13 or within the stand 30. Alternatively, these components may be disposed externally in a standalone housing.

With further reference to FIG. 1, the flat panel touch screen monitor 12 includes an audio/video message circuit such that one or more desired audio/video messages associated with displayed icons and/or text regions can be played upon touching a selected icon or text region using a finger or a stylus. Specifically, a series of touch-sensitive switches are disposed with the monitor 12 corresponding to the location of the icon or text region. In this manner, a user may selectively touch an icon or text region to play a corresponding audio/video using the monitor 12 and speakers 20. Under control of the microprocessor 60, digital information representing the desired audio/video message is: (1) retrieved from the memory 66; (2) converted to an analog signal; and (3) transmitted to the speakers 20 to produce the desired audio message perceptible to a human.

According to further embodiments of the present invention, the community message board 10 may include a voice recognition system such that a user may speak commands to operate the message board. The voice recognition system may be configured to recognize a specific user by the unique characteristics of their voice. Voices that are not recognized by the voice recognition systems are treated as community users, such that access to user calendars and the security mode is not allowed.

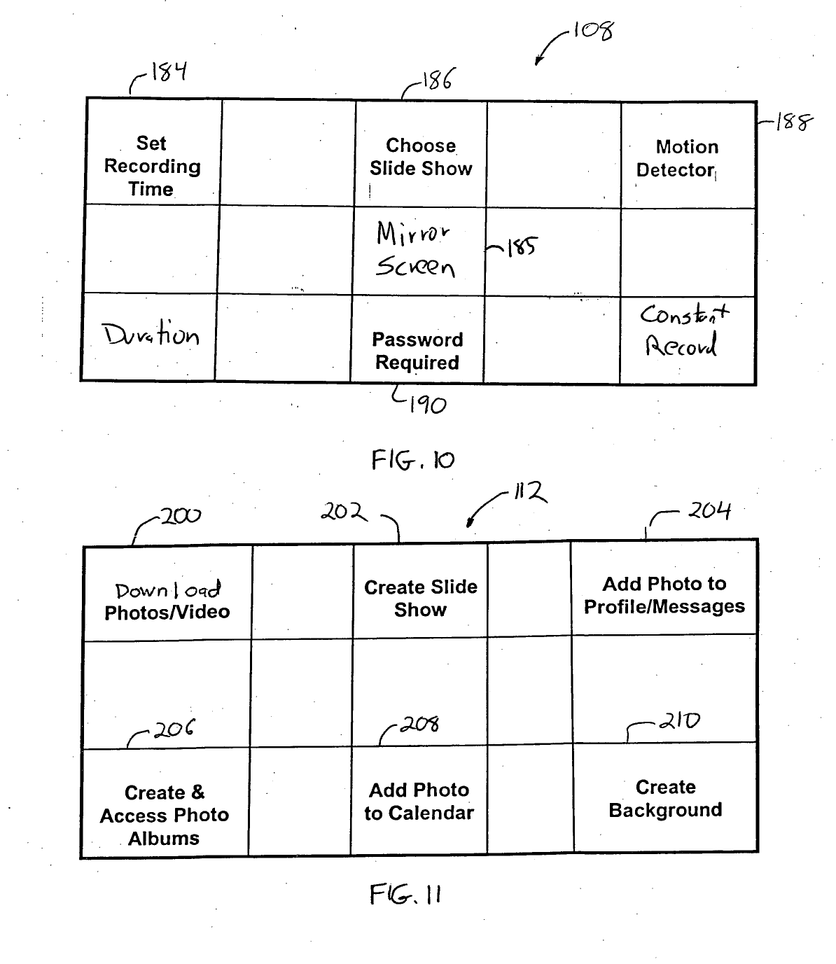

In accordance with the principles of the present invention, the community message board 10 may be operated using a software program comprising machine-readable instructions for processing user inputs and controlling the components/peripheral devices of the community message board. In addition, the software program provides a series of screens to be selectively displayed on the monitor 12, including home screen 100 (FIG. 6), user mailbox screen 102 (FIG. 7), user calendar screen 104 (FIG. 8), community calendar screen 116 (FIG. 9), security mode screen 108 (FIG. 10), media center screen 112 (FIG. 11).

Referring to FIG. 6, exemplary user home screen 100 comprises a plurality of touch-sensitive text regions 104, 108, 110, 112, 114, 116 that are linked with various additional screens that are described hereinbelow. Specifically, the touch-sensitive text regions include user mailbox 102, user calendar 104, security mode 108, user profile setup 110, media center 112, general information page 114 and community calendar 116. The touch-sensitive text regions of the user home screen 100 permit a user to jump to a selected screen by touching the corresponding text region with a finger or a stylus. According to an alternative embodiment of the invention, the touch-sensitive regions 104, 108, 110, 112, 114, 116 may feature icons rather than text. For example, the “user mailbox” text may be replaced with an icon depicting an actual mailbox, whereas the “user calendar” text may be replaced with an icon depicting an actual calendar. Of course, as would be understood by those of ordinary skill in the art many variations of icons and text language are possible without departing from the scope of the present invention.

According to an aspect of the present invention, the user mailbox 102 comprises a personal video mailbox for, wherein a user may record and send audio and/or video messages to other users of the community message board 10. The video mailbox preferably includes options for saving video messages for later playback and for selectively deleting old video messages. From within the video mailbox, the user is directed to set up a personal profile including an individual greeting, calendar, photo bank, and user password.

FIG. 7 depicts an exemplary user mailbox screen 102 comprising a plurality of touch-sensitive text regions providing a plurality of mailbox options for controlling user mailbox functionality. In particular, the touch-sensitive regions include create message 122, attach photo 124, record greeting 126, delete message 128, save message 130, sent messages 132, new messages 134, user profile photo 136, community message 138 and saved messages 140. These messages may include audio messages as well as video messages that are recorded using the microphone 14 and video camera 16. Advantageously, the touch-sensitive text regions 122, 124, 126, 128, 130, 132, 134, 136, 138, 140 allow functional control of the user mailbox using a finger or a stylus. According to further embodiments of the invention, touch-sensitive regions 122, 124, 126, 128, 130, 132, 134, 136, 138, 140 may feature icons rather than text. As will be appreciated by one of ordinary skill in the art many icon and text language variations may be employed without departing from the scope of the present invention.

According to a further aspect of the present invention, each user of the community message board 10 is provided with a personal calendar that may be customized to their own schedule. A personal calendar may be accessed by typing in a corresponding user name and personal password. Once the calendar is opened, the user may enter information such as selected holidays, birthdays, appointments, deadlines, meetings and other events and dates. Additionally, the personal calendar also features a clock that is configured to provide the correct time in any time zone worldwide.

FIG. 8 depicts an exemplary user calendar screen 104 comprising a plurality of touch-sensitive text regions including appointments 150, alarms, 152, time 154, photo/video alarms 156, view calendar 158, self reminders 160, general information page 162 and security mode 164. Touch-sensitive text regions 150, 152, 154, 156, 158, 160, 162, 164 permit functional control of user calendar screen 104, including creating, saving, sending and deleting audio and/or video messages. Similar to previous embodiments, various icons may be substituted for the text regions without departing from the scope of the invention. According to a preferred implementation, view calendar screen 158 appears as a full size desk calendar, such that the user may click on any day to view the appointments or other details regarding that day.

The user calendar is provided with an alarm system for automatically reminding the user of selected holidays, birthdays, appointments, deadlines, meetings and other events/dates that have been entered into the personal calendar. By way of example, the alarm system may feature automatic pop-up windows including text and graphics for providing the user with selected information at predetermined times. Alternatively, the alarm system may feature other conventional forms of electronic communication such as a blinking icon that may be selected to reveal the underlying message. According to some embodiment of the invention, the user calendar may be configured to deliver a photo birthday notification to selected users of the community message board 10. The photo birthday notification may provide a reminder in advance of upcoming birthdays.

According to another aspect of the invention, the community message board 10 includes a community notepad and calendar. This community calendar comprises a free access electronic planner for a single location, wherein any user may post a message for any other user or combination of users, including general posts that are directed to all users. The messages may include notifications, appointment reminders, family or group activity reminders, photo birthday notifications and other messages. Advantageously, the community calendar provides an electronic planner for a selected community such as a household or an office, wherein all members of the community are users that have access to the calendar. Alternatively, only some of the members of the community are provided with user access to the community calendar. According to the preferred embodiment, all users (including guests) may access the community calendar without entering a personal password. According to alternative embodiments, a personal password is required to access the community calendar.

FIG. 9 depicts an exemplary community calendar screen 116 comprising a plurality of touch-sensitive text regions including appointments 170, view calendar 172, leave message 174, set alarm 176 and general information page 178. Touch-sensitive text regions 170, 172, 174, 176, 178 allow user control of community calendar screen 116. Again, the text regions of FIG. 9 may be replaced (or partially replaced) by icons without departing from the scope of the invention.

According to an additional aspect of the invention, the community message board 10 includes a security mode in which the video camera 14 is employed as a monitoring device. When in the security mode, the video camera 14 continuously records a predetermined location (e.g., the entrance to a building such as a house or office) while the community message board 10 displays a slide show or mirror screen. Preferably, the viewing angle of video camera 14 is adjustable in order to achieve the desired field of view. According to some embodiments, the community message board 10 includes a motion detector, wherein the video camera 14 is configured to record only when movement has been detected.

FIG. 10 depicts an exemplary security mode screen 108 comprising a plurality of touch-sensitive text regions including set recording time 184, mirror screen 185, choose slide show 186, motion detector 188, duration 189, password required 190 and constant record 191. Touch-sensitive text regions 184, 186, 187, 188, 189, 190, 191 permit functional control of security mode screen 108, including the ability to select the duration and type of security employed. It is preferred that the security mode screen may not be accessed from the community calendar, such that only users having a password may access the security mode screen 108 for selection of the security options.

According to a further aspect of the invention, each user of the community message board 10 is provided with access to a media center for the creation of slide shows and photo albums. Specifically, the memory card disk drives 20 and data ports 22 can be used for downloading and storing photos and video clips that make up the slide shows and photo albums. For example, a USB port is provided for downloading photos and video from digital and/or video cameras and a memory card disk drive is provided for storing the photos and video.

FIG. 11 depicts an exemplary media center screen 112 comprising a plurality of touch-sensitive text regions including download photos/video 200, create slide show 202, add photos to profile/messages 204, create & access photo albums 206, add photo to calendar 208 and create background 210. Touch-sensitive text regions 200, 202, 204, 206, 208, 210 permit user control of media center screen 112. Similar to previous embodiments, these text regions may be replaced by icons without departing from the scope of the invention.

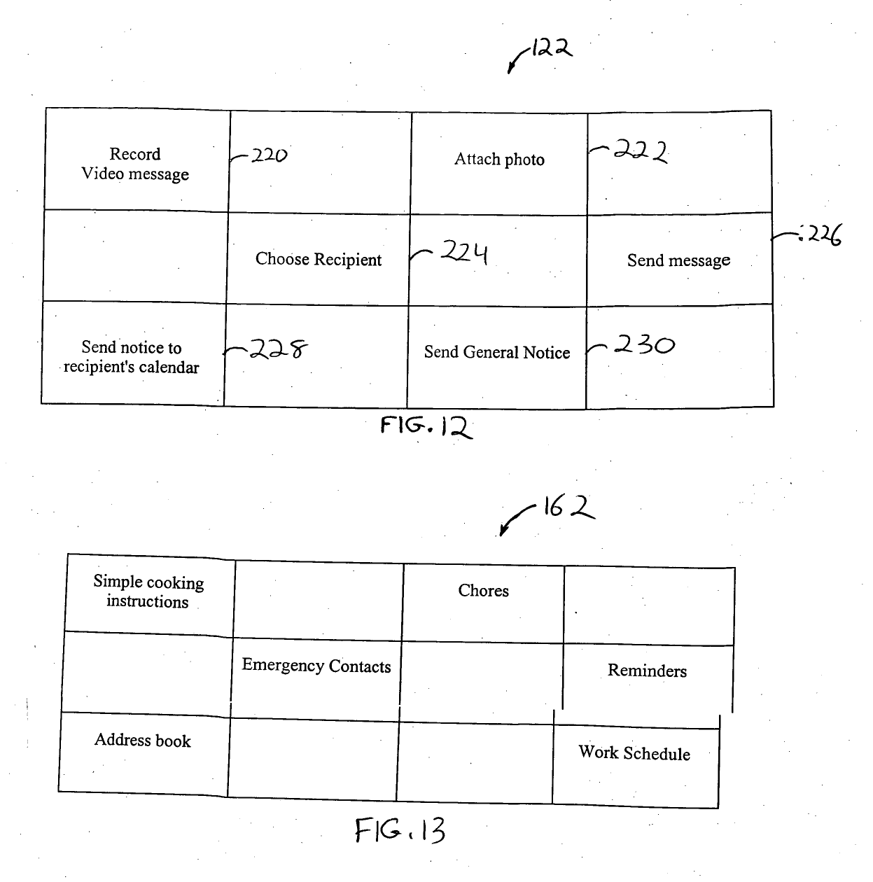

FIG. 12 depicts an exemplary create messages screen 122, which may be brought up by touching the create message region of the user mailbox screen 102. Create messages screen 122 comprises a plurality of touch-sensitive text regions including record video message 220, attach photo 222, choose recipient 224, send message 226, send notice to recipient's calendar 228 and send general notice 230.

FIG. 13 depicts the general information page 162, which may be brought up by touching the general information region on the user calendar screen 104. General information page 162 comprises a plurality of touch-sensitive text regions including simple cooking instructions 240, chores 242, emergency contacts 244, reminders 246, address book 248 and work schedule 250. As would be understood by those of ordinary skill in the art, additional and/or different text regions may be provided without departing from the scope of the invention.

According to a further aspect of the invention, each user of the community message board 10 is provided with access to a general information page 114 for displaying selected general community information such as household or office reminders, general instructions and persons to call in case of emergencies. For example, a household user may post a universal message on the general information page 114 to notify all household members of upcoming household events and activities. Similarly, an office user may post a universal message on the general information page 114 to notify all office members of upcoming office events and activities.

Thus, it is seen that a community message board is provided. One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well.

What is claimed is:

1. A community message board for a plurality of users at a single location, the community message board comprising:
a monitor for broadcasting audio and video messages;
a video camera for capturing video inputs; and
a microphone for recording audio inputs.

2. The community message board of claim 1, wherein the monitor comprises a flat panel touch screen including a touch screen keyboard for entering alphanumeric text.

3. The community message board of claim 1, further comprising a voice recognition system such that a user may speak commands to operate the message board.

4. The community message board of claim 1, wherein the single location comprises a residence or office.

5. The community message board of claim 1, wherein the monitor is disposed within an interchangeable frame that is selected from a plurality of frame styles, colors and materials.

6. The community message board of claim 1, further comprising one or more memory card disk drives and one or more data ports.

7. The community message board of claim 1, further comprising a microprocessor for controlling the functionality of the message board, audio circuitry, video circuitry, memory for storing audio and video data, interface circuitry for providing user interface functionality, and input/output circuitry for communicating with one or more peripheral devices such as the video camera, microphone and speakers.

8. The community message board of claim 1, further comprising an audio/video message circuit such that one or more desired audio/video messages associated with displayed icons and text regions can be played upon touching a selected icon or text region using a finger or a stylus.

9. The community message board of claim 8, wherein digital information representing the desired audio/video message is retrieved from the memory, converted to an analog signal and transmitted to the speakers to produce the desired audio message perceptible to a human.

10. The community message board of claim 1, further comprising a software program comprising machine-readable instructions for processing user inputs and controlling peripheral devices including the video camera and microphone.

11. The community message board of claim 10, wherein the software program provides a series of screens to be selectively displayed on the monitor, including a home screen, a user mailbox screen, a user calendar screen, a community calendar screen, a security mode screen and a media center screen

12. The community message board of claim 1, wherein each user is provided with a user mailbox for sending audio/video messages to other users of the community message board.

13. The community message board of claim 1, wherein each user is provided with a personal calendar for entering and automatically reminding the user of selected holidays, birthdays, appointments, deadlines, meetings and other dates.

14. The community message board of claim 1, further comprising a community calendar that is accessible by all users, wherein any user may post a message for any other user or combination of users, including general posts that are directed to all users.

15. The community message board of claim 1, further comprising a security mode in which the video camera is employed as a monitoring device.

16. The community message board of claim 15, wherein the video camera is set to continuously record a predetermined location while the community message board displays a slide show or mirror screen.

17. The community message board of claim 15, wherein the video camera includes a motion detector such that the video camera is configured to record only when movement has been detected.

18. The community message board of claim 1, further comprising a media center for the creation of slide shows and photo albums.

19. A community message board for a plurality of users at a single location such as a residence or office, the community message board comprising:
a monitor for broadcasting audio and video messages;
a video camera for capturing video inputs;
a microphone for recording audio inputs; and
a software program comprising machine-readable instructions for processing user inputs and controlling peripheral devices including the video camera and microphone.

20. A community message board for a plurality of users at a single location, the community message board comprising:
a monitor for broadcasting audio and video messages;
a video camera for capturing video inputs;
a microphone for recording audio inputs; and
a software program comprising machine-readable instructions for providing a user mailbox screen, a user calendar screen, a community calendar screen, a security mode screen and a media center screen.
